(19) United States
(12) Patent Application Publication
(10) Pub. No.: US 2016/0337667 A1
(43) Pub. Date: Nov. 17, 2016

(54) IMAGE CODING DEVICE AND IMAGE CODING METHOD

(71) Applicant: FUJITSU LIMITED, Kawasaki-shi (JP)

(72) Inventor: Hirofumi Nagaoka, Kawasaki (JP)

(73) Assignee: FUJITSU LIMITED, Kawasaki-shi (JP)

(21) Appl. No.: 15/133,335

(22) Filed: Apr. 20, 2016

(30) Foreign Application Priority Data
May 15, 2015 (JP) 2015-100211

(51) Int. Cl. H04N 19/91; H04N 19/70

(52) U.S. Cl. CPC H04N 19/91; H04N 19/70

(57) ABSTRACT

An image coding device includes: a storage unit; and an operation unit configured to execute a procedure, the procedure including: calculating a plurality of syntax elements corresponding to a plurality of divided regions obtained by dividing an image along horizontal dividing lines; storing the plurality of syntax elements in the storage unit; and executing first entropy coding processing for a first divided region among the plurality of divided regions, in parallel with second entropy coding processing for a second divided region adjacent below the first divided region among the plurality of divided regions, wherein the second entropy coding processing includes processing of reading a syntax element corresponding to the first divided region among the plurality of syntax elements from the storage unit.

### CROSS-REFERENCE TO RELATED APPLICATION

This application is based upon and claims the benefit of priority of the prior Japanese Patent Application No. 2015-100211, filed on May 15, 2015, the entire contents of which are incorporated herein by reference.

### FIELD

The embodiments discussed herein are related to an image coding device and an image coding method.

### BACKGROUND

The H.265/HEVC (high efficiency video coding) standard (hereinafter abbreviated as the “HEVC standard”) has attracted attention as the next-generation video coding standard. The HEVC standard has compression performance approximately double that of the conventional H.264/MPEG-4 AVC (moving picture experts group-phase 4 advanced video coding) standard. Moreover, in the HEVC, measures are taken to execute coding processing in parallel, such as wavefront parallel processing (WPP).

As an example of the video coding technology, there has been proposed a technology to avoid, during coding of a block to be processed, the use of data from a block positioned thereabove as context information.

Related techniques are disclosed in, for example, Japanese National Publication of International Patent Application No. 2014-522603.

### SUMMARY

According to an aspect of the invention, an image coding device includes: a storage unit; and an operation unit configured to execute a procedure, the procedure including: calculating a plurality of syntax elements corresponding to a plurality of divided regions obtained by dividing an image along horizontal dividing lines; storing the plurality of syntax elements in the storage unit; and executing first entropy coding processing for a first divided region among the plurality of divided regions, in parallel with second entropy coding processing for a second divided region adjacent below the first divided region among the plurality of divided regions, wherein the second entropy coding processing includes processing of reading a syntax element corresponding to the first divided region among the plurality of syntax elements from the storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example and a processing example of an image coding device according to a first embodiment;

FIG. 2 is a diagram illustrating a configuration example of an image processing circuit according to a second embodiment;

FIG. 3 is a diagram illustrating an internal configuration example of a syntax element generator and an entropy coder;

FIG. 4 is a diagram illustrating an internal configuration example of a table creator;

FIG. 5 is a diagram illustrating a configuration example of a syntax region and a context region;

FIG. 6 is a reference diagram for explaining coding processing by WPP;

FIG. 7 is a diagram (Part 1) illustrating an example of coding processing according to the second embodiment;

FIG. 8 is a diagram (Part 2) illustrating an example of coding processing according to the second embodiment;

FIG. 9 is a timing chart illustrating an example of processing execution timing;

FIG. 10 is a flowchart illustrating an example of an overall control procedure for the coding processing;

FIG. 11 is a flowchart illustrating a processing example of syntax element generation control;

FIG. 12 is a flowchart illustrating a processing example of entropy coding control;

FIG. 13 is a flowchart illustrating a processing example of context table creation;

FIG. 14 is a flowchart illustrating a processing example of entropy coding;

FIG. 15 is a diagram illustrating a hardware configuration example of an information processing device including an image processing circuit;

FIG. 16 is a diagram illustrating a configuration example of an information processing device according to a third embodiment;

FIG. 17 is a diagram illustrating an example of syntax element generation processing in each tile;

FIG. 18 is a diagram illustrating an example of entropy coding processing in each tile;

FIG. 19 is a diagram illustrating a processing example when entropy coding in a certain tile is completed;

FIG. 20 is a flowchart illustrating an example of a control procedure for syntax element generation by a processor; and

FIG. 21 is a flowchart illustrating an example of a control procedure for entropy coding by the processor.

### DESCRIPTION OF EMBODIMENTS

For execution of entropy coding using divided regions obtained by dividing an image along horizontal dividing lines as a unit, there is a case where a syntax element in a divided region adjacent above a syntax element to be processed has to be referred to, in order to entropy code the syntax element to be processed. In such a case, if the divided regions adjacent to each other try to be entropy coded in parallel, entropy coding at a certain position on the lower divided region may not be executed until a syntax element is generated at the same position as the divided region thereabove.

Depending on a difference in image complexity between the divided regions and the like, the speed of entropy coding may be faster in the lower divided region than the upper divided region. However, in such a case, there is a possibility that waiting time is desired for generation of a syntax element in the upper divided region in the middle of entropy coding of the lower divided region. Such waiting time increases processing time, thus causing deterioration in processing efficiency of the entropy coding.

Hereinafter, with reference to the drawings, description is given of embodiments of an image coding device and an image coding method capable of improving processing efficiency during parallel execution of entropy coding.

### First Embodiment

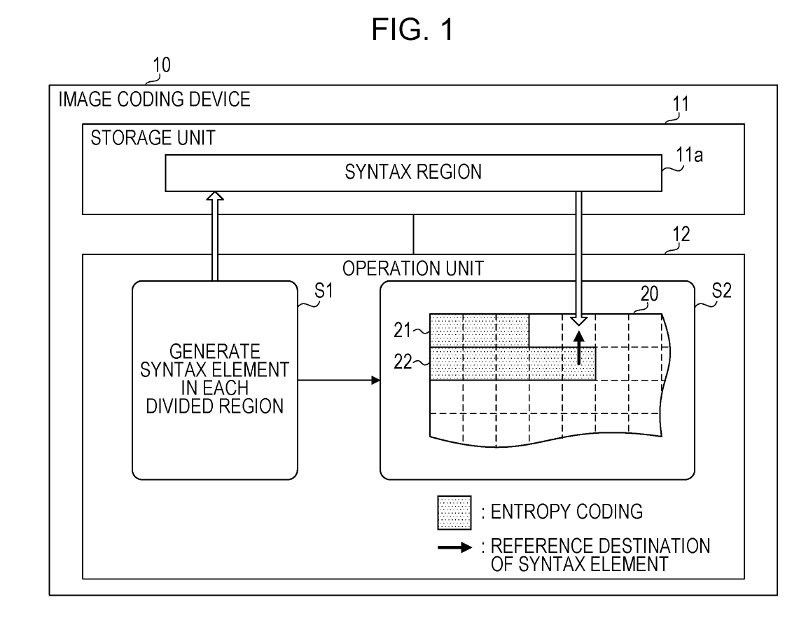

FIG. 1 is a diagram illustrating a configuration example and a processing example of an image coding device according to a first embodiment. An image coding device 10 illustrated in FIG. 1 is a device for coding an image 20, and includes a storage unit 11 and an operation unit 12. The storage unit 11 is implemented as a volatile storage such as a random access memory (RAM) or a non-volatile storage such as a hard disk drive (HDD) and a flash memory, for example. The operation unit 12 is a processor, for example. Note that the processor is realized by a central processing unit (CPU), a micro processing unit (MPU), a digital signal processor (DSP), an application specific integrated circuit (ASIC), a programmable logic device (PLD) or a combination of two or more of the above, for example.

The operation unit 12 may execute entropy coding for each of divided regions obtained by dividing the image 20 along horizontal dividing lines. The operation unit 12 executes the following processing to code the image.

The operation unit 12 calculates a syntax element for each of the divided regions of the image 20, and stores the syntax element in a syntax region 11a, for example, of the storage unit 11 (Operation S1). The syntax element is an element included in an image coding stream, and includes management information (header information) and information indicating the image itself, such as coefficients and vector.

After storing the syntax elements for the respective divided regions in the syntax region 11a, the operation unit 12 executes entropy coding processing on a first divided region 21 in parallel with entropy coding processing on a second divided region 22 adjacent below the first divided region 21 (Operation S2).

In the entropy coding processing on the first divided region 21, syntax elements corresponding to the first divided region 21 are read from the syntax region 11a, and the read syntax elements are entropy coded. Meanwhile, in the entropy coding processing on the second divided region 22, the syntax elements corresponding to the first divided region 21 are read from the syntax region 11a, and the read syntax elements are entropy coded. Furthermore, the entropy coding processing on the second divided region 22 includes processing of reading the syntax elements corresponding to the upper first divided region 21 from the syntax region 11a. The read syntax elements are used for entropy coding of the second divided region 22. For example, in entropy coding of one of pixels in the second divided region 22, a syntax element corresponding to a pixel adjacent above that pixel is used.

Here, depending on image complexity and the like within the divided regions, time desired for the entropy coding may vary from one divided region to another. In the example of FIG. 1, it is assumed that the time desired for the entropy coding processing is shorter for the second divided region 22 than the first divided region 21. In this embodiment, after the syntax elements for at least the first divided region 21 are stored in the syntax region 11a, the entropy coding for the first and second divided regions 21 and 22 is started. Therefore, the entropy coding processing on the second divided region 22 may be executed by reading syntax information on the first divided region 21, which is already stored in the syntax region 11a. Thus, no waiting time occurs for calculation of the syntax elements corresponding to the first divided region 21, in the middle of the entropy coding of the second divided region 22. As a result, the operation unit 12 may complete the entropy coding for the second divided region 22 first before the first divided region 21.

Thus, according to this embodiment, parallelism of the entropy coding for the respective divided regions may be improved, and processing efficiency may be enhanced.

### Second Embodiment

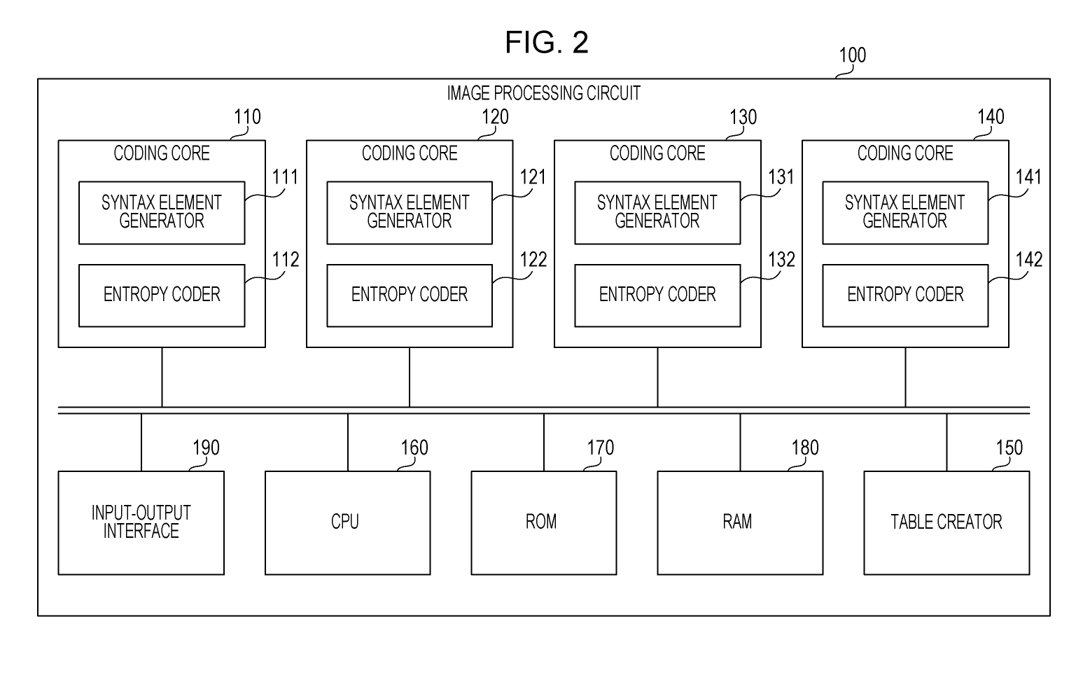

FIG. 2 is a diagram illustrating a configuration example of an image processing circuit according to a second embodiment. An image processing circuit 100 is a circuit capable of coding an image according to the H.265/HEVC standard (hereinafter abbreviated as the “HEVC standard”). The image processing circuit 100 is realized as a semiconductor device such as an SoC (System-on-a-Chip), for example.

The image processing circuit 100 includes coding cores 110, 120, 130, and 140, a table creator 150, a CPU 160, a read only memory (ROM) 170, a RAM 180, and an input-output interface 190, which are connected to each other through a bus.

In the image processing circuit 100, image data inputted through the input-output interface 190 is stored in the RAM 180. The image data stored in the RAM 180 is compression-coded by processing performed by the coding cores 110 to 140 and the table creator 150. A coding stream obtained by the compression coding processing is temporarily stored in the RAM 180, and then outputted to the outside of the image processing circuit 100 through the input-output interface 190.

The coding cores 110 to 140 are processors, for example. In this case, each of the coding cores 110 to 140 is realized by a CPU, an MPU, a DSP, an ASIC, a PLD or a combination of two or more of the above, for example.

The coding cores 110 to 140 execute the compression coding processing, except for context table creation to be described later, under the control of the CPU 160. The CPU 160 allocates coding tree block (CTB) lines to be processed to the coding cores 110 to 140, respectively. The coding cores 110 to 140 execute processing for the CTB lines allocated by the CPU 160, and, upon completion of the execution, notifies the CPU 160 to that effect. Here, the coding cores 110 to 140 execute the processing in parallel with each other.

Here, the CTB represents a minimum unit of picture division. The CTB is a square image region, and the number of pixels on a side is set to 16, 32 or 64. The CTB line means a region formed by integrating the CTBs from the leftmost to the rightmost, which are adjacent to each other in a horizontal direction on a picture.

The processing to be executed by the coding cores 110 to 140, respectively, is classified broadly into syntax element generation processing and entropy coding processing. The syntax element generation processing includes processing such as inter prediction (inter-frame prediction), intra prediction (intra-frame prediction), orthogonal transform of a prediction error signal, and quantization. By the syntax element generation processing, a plurality of syntax elements are outputted eventually. The syntax elements are data elements included in a bit stream, and include picture or slice management information (header information), slice data (coefficients, vector and the like), and the like. Meanwhile, the entropy coding processing is coding processing to allocate codes of different lengths to the syntax elements based on occurrence probability thereof. A coding stream is generated as a result of the entropy coding processing.

The coding core 110 includes a syntax element generator 111 and an entropy coder 112. The coding core 120 includes a syntax element generator 121 and an entropy coder 122. The coding core 130 includes a syntax element generator 131 and an entropy coder 132. The coding core 140 includes a syntax element generator 141 and an entropy coder 142. The syntax element generators 111, 121, 131, and 141 have the same configuration, and execute the syntax element generation processing described above for each of the CTB lines. The entropy coders 112, 122, 132, and 142 have the same configuration, and execute the entropy coding processing described above for each of the CTB lines. Note that the syntax element generator and the entropy coder in the same coding core may have CTB lines of different pictures as processing targets.

The table creator 150 creates a context table to be used for the entropy coding processing for each CTB line, based on the syntax elements generated by the coding cores 110 to 140. As described later, the table creator 150 calculates context tables for all CTB lines in a certain picture before execution of entropy coding processing on the picture by each of the entropy coders 112, 122, 132, and 142, and stores the context tables in the RAM 180. Thus, there are no longer restrictions on when to start the entropy coding processing between the CTB lines. As a result, parallelism of the entropy coding processing is improved.

The CPU 160 controls the respective units in the image processing circuit 100 in an integrated manner. For example, the CPU 160 allocates pictures and CTB lines to be processed to the syntax element generators 111, 121, 131, and 141 and the entropy coders 112, 122, 132, and 142. The CPU 160 also instructs the syntax element generators 111, 121, 131, and 141, the entropy coders 112, 122, 132, and 142 and the table creator 150 to start processing, and receives processing completion notices therefrom. Note that the above processing by the CPU 160 is realized by the CPU 160 executing a program stored in the ROM 170.

The ROM 170 stores programs to be executed by the CPU 160 and various data to be desired for execution of the programs, for example. The RAM 180 temporarily stores various data to be used for processing in the image processing circuit 100. For example, the RAM 180 stores image data inputted through the input-output interface 190 and reference image data to be referred to by the coding cores 110 to 140. The RAM 180 also stores the syntax elements generated by the syntax element generators 111, 121, 131, and 141 and the context tables created by the table creator 150. A storage region for the syntax elements and the context tables functions as a shared buffer shared by the coding cores 110 to 140. Moreover, the RAM 180 stores the coding streams generated by the entropy coders 112, 122, 132, and 142. The coding streams stored in the RAM 180 are outputted through the input-output interface 190. The input-output interface 190 controls input and output of data from and to the outside of the image processing circuit 100.

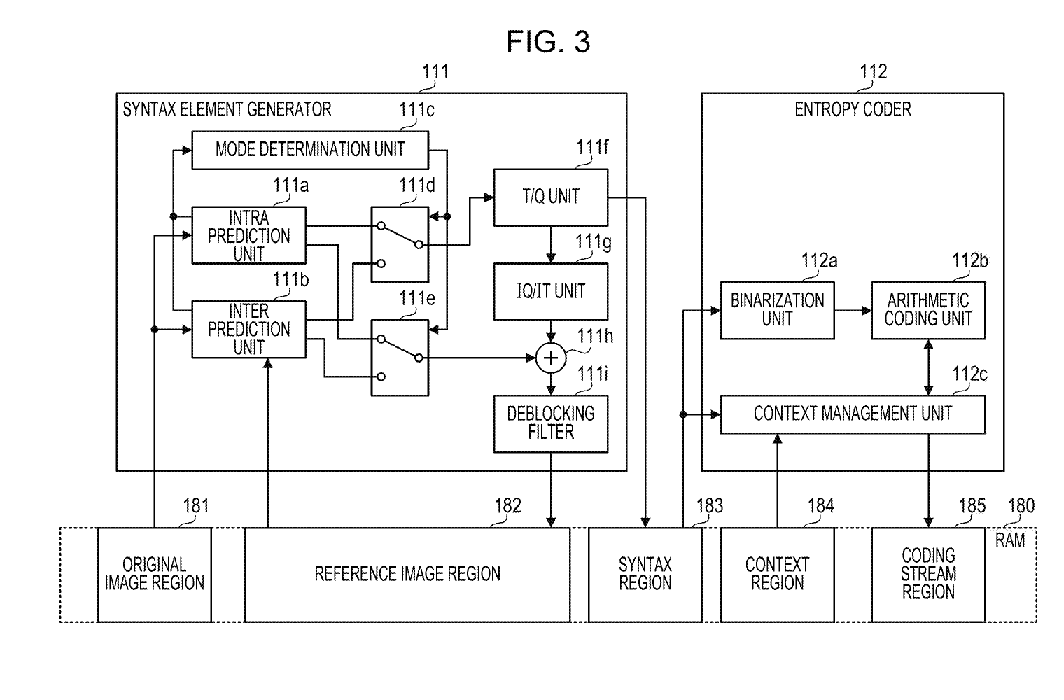

FIG. 3 is a diagram illustrating an internal configuration example of the syntax element generator and the entropy coder. Note that, as described above, the syntax element generators 111, 121, 131, and 141 have the same configuration, and the entropy coders 112, 122, 132, and 142 have the same configuration. Therefore, in FIG. 3, only the syntax element generator 111 and the entropy coder 112 included in the coding core 110 are described as representative thereof.

FIG. 3 also illustrates an example of various storage regions provided in the RAM 180. In the RAM 180, an original image region 181, a reference image region 182, a syntax region 183, a context region 184 and a coding stream region 185. The original image region 181 stores image data inputted from the input-output interface 190. The reference image region 182 stores reference image data to be used for processing by the syntax element generators 111, 121, 131, and 141. The syntax region 183 stores the syntax elements generated by the syntax element generators 111, 121, 131, and 141. The context region 184 stores the context tables created by the table creator 150. The coding stream region 185 stores the coding streams generated by the entropy coders 112, 122, 132, and 142.

The syntax element generator 111 includes an intra prediction unit 111a, an inter prediction unit 111b, a mode determination unit 111c, selectors 111d and 111e, a transform/quantization (T/Q) unit 111f, an inverse quantization/inverse transform (IQ/IT) unit 111g, an adder 111h, and a deblocking filter 111i.

The intra prediction unit 111a performs intra-frame prediction for a picture read from the original image region 181, and outputs data of a predicted image. The intra prediction unit 111a outputs a prediction error signal by calculating a difference between the predicted image and the original image.

The inter prediction unit 111b calculates a motion vector based on the original image data read from the original image region 181 and the reference image data read from the reference image region 182. The inter prediction unit 111b uses the calculated motion vector to motion compensate the reference image data read from the reference image region 182, and outputs the motion-compensated predicted image data. The inter prediction unit 111b outputs a prediction error signal by calculating a difference between the predicted image and the original image.

The mode determination unit 111c allows the intra prediction unit 111a or the inter prediction unit 111b to execute the processing based on a mode of a picture to be coded. The selector 111d outputs the prediction error signal outputted from the intra prediction unit 111a or the inter prediction unit 111b to the T/Q unit 111f according to a selection signal from the mode determination unit 111c. The selector 111e outputs the predicted image data outputted from the intra prediction unit 111a or the inter prediction unit 111b to the adder 111h according to a selection signal from the mode determination unit 111c.

The T/Q unit 111f transforms the prediction error signal inputted from the selector 111d to generate a signal separated into horizontal and vertical frequency components. The T/Q unit 111f quantizes the generated signal. Thus, syntax elements are generated and the generated syntax elements are stored in the syntax region 183.

The IQ/IT unit 111g inverse-quantizes the quantized data generated by the T/Q unit 111f and further inverse-transforms the quantized data, thereby restoring the prediction error signal. The adder 111h generates reference image data by adding up the predicted image data inputted from the selector 111e and the prediction error signal from the IQ/IT unit 111g. The deblocking filter 111i performs deblocking filter processing on the generated reference image data, and stores the processed data in the reference image region 182.

The entropy coder 112 includes a binarization unit 112a, an arithmetic coding unit 112b, and a context management unit 112c. Note that the binarization unit 112a, the arithmetic coding unit 112b and the context management unit 112c are functions to entropy code the data below a slice segment data (slice_segment_data) layer among the syntax elements by context-based adaptive binary arithmetic coding (CABAC). Although the entropy coder 112 actually also includes a function to entropy code the syntax elements (management information) above the slice segment data layer by using a 0th order exponential Golomb code, description thereof is omitted here.

The binarization unit 112a converts the syntax element read from the syntax region 183 into a binary signal. The arithmetic coding unit 112b uses a method corresponding to the kind of the syntax element to calculate context information based on the converted binary signal. The context information is a probability value of the binary signal having bits of “0” or “1”. The arithmetic coding unit 112b uses the calculated context information to arithmetically code the syntax element.

The context management unit 112c controls calculation processing of the context information in an integrated manner. For example, the context management unit 112c initializes the arithmetic coding unit 112b and sets initial context information for the arithmetic coding unit 112b. During coding of the second CTB line and thereafter, the context management unit 112c reads the initial context information from the context table generated by the table creator 150 and stored in the context region 184. On the other hand, during syntax element coding which uses CTB syntax elements adjacent on the upper and left sides, the context management unit 112c reads the CTB syntax elements adjacent on the upper and left sides from the syntax region 183. Moreover, the context management unit 112c generates a coding stream by using a code string outputted from the arithmetic coding unit 112b, and stores the coding stream in the coding stream region 185.

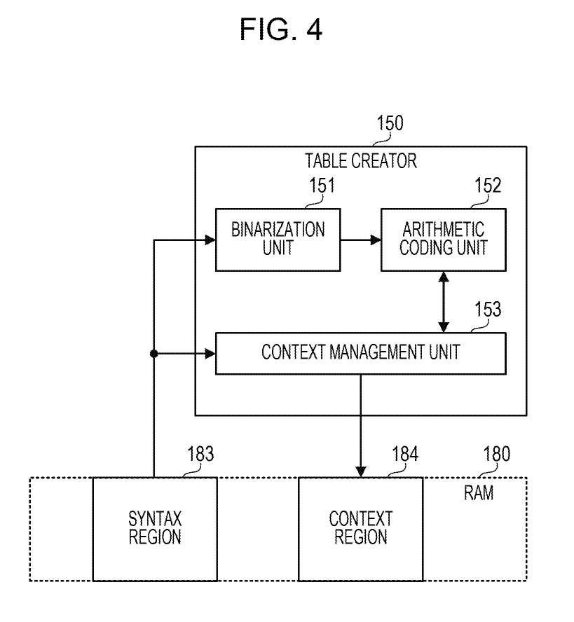

FIG. 4 is a diagram illustrating an internal configuration example of the table creator. The table creator 150 includes a binarization unit 151, an arithmetic coding unit 152, and a context management unit 153.

The table creator 150 calculates context information on the first and second CTBs among the CTBs in the CTB lines. The binarization unit 151 converts the syntax element read from the syntax region 183 into a binary signal. The arithmetic coding unit 152 uses a method corresponding to the kind of the syntax element to calculate context information based on the converted binary signal.

The context management unit 153 controls calculation processing of the context information in an integrated manner. For example, upon completion of the coding processing of the first and second CTBs on the CTB line, the context management unit 153 registers the calculated context information in the context table in the context region 184. The registered context table is referred to when the entropy coders 112, 122, 132, and 142 start entropy coding of the second CTB line and thereafter.

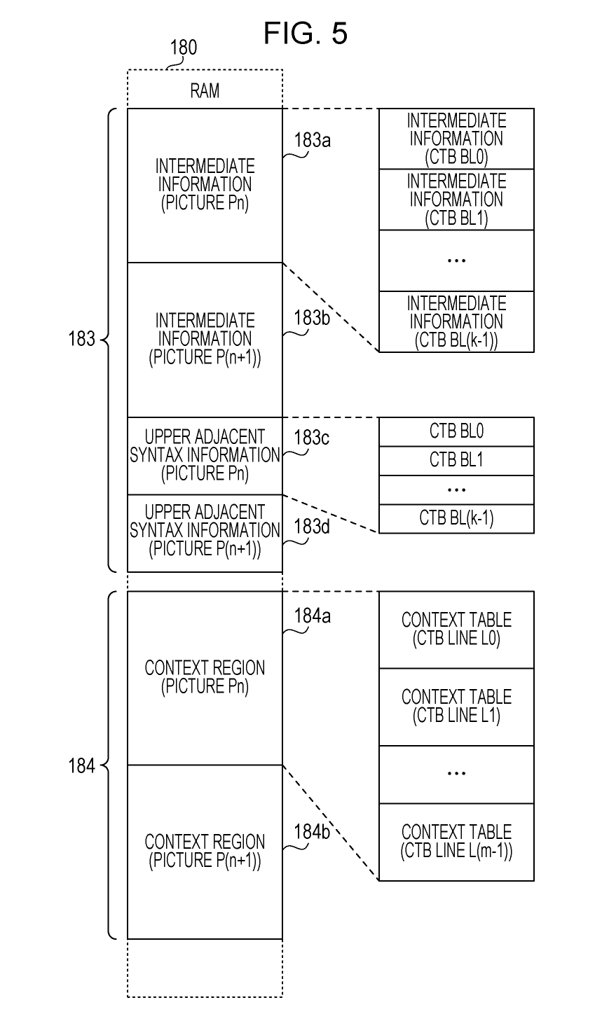

FIG. 5 is a diagram illustrating a configuration example of the syntax region and the context region. Note that, in the following description, the n-th picture is described as “picture Pn”. Moreover, it is assumed that the number of CTB lines on one picture is m, and the x-th CTB line is described as “CTB line L(x-1)”. More specifically, one picture has m CTB lines from CTB line L0 to CTB line L(m-1). Furthermore, it is assumed that the number of CTBs on one picture is k, and the x-th CTB is described as “CTB BL(x-1)”. More specifically, one picture has k CTBs from CTB BL0 to CTB BL(k-1).

The syntax region 183 includes: regions 183a and 183b storing intermediate information; and regions 183c and 183d storing upper adjacent syntax elements. One of the regions 183a and 183b stores intermediate information on a certain picture, and the other stores intermediate information on the next picture. For example, the region 183a stores intermediate information on the n-th picture Pn, and the region 183b stores intermediate information on the (n+1)-th picture P(n+1). In this case, when entropy coding of the n-th picture Pn is completed, the region 183a is updated using the intermediate information on the (n+2)-th picture P(n+2).

The regions 183a and 183b store intermediate information on the k CTBs BL1 to BL(k-1) within a picture, respectively. The intermediate information means all syntax elements on and below the slice segment data layer. For example, the intermediate information includes syntax elements such as “end_of_slice_segment_flag”, “sao_merge_flag”, “pred_mode_flag”, “part_mode”, “cu_skip_flag”, and “coeff_abs_level_remaining”.

One of the regions 183c and 183d stores an upper adjacent syntax element of a certain picture, and the other stores an upper adjacent syntax element of the next picture. For example, the region 183c stores an upper adjacent syntax element of the n-th picture Pn, and the region 183d stores an upper adjacent syntax element of the (n+1)-th picture P(n+1). In this case, when entropy coding of the n-th picture Pn is completed, the region 183c is updated using the upper adjacent syntax element of the (n+2)-th picture P(n+2).

The regions 183c and 183d store upper adjacent syntax elements of the k CTBs BL1 to BL(k-1) within a picture, respectively. During entropy coding, context information on a certain CTB is determined based on a syntax element of the CTB adjacent on the upper side and a syntax element of the CTB adjacent on the left side. The upper adjacent syntax element is the syntax element of the CTB adjacent on the upper side.

To be more specific, the upper adjacent syntax element includes “cu_skip_flag” corresponding to each coding unit (CU) at the lower end within the appropriate CTB. The CU is a region of a coding unit for dividing the CTB. In the HEVC standard, the CTB may be divided into CUs of a variable size based on recursive quadtree block segmentation. “cu_skip_flag” is a flag indicating whether or not there are no syntax elements, after the flag, other than those of a merge candidate index when the current CU is P slice or B slice. When the CU has 8 pixels×8 pixels, the upper adjacent syntax element stores eight flags “cu_skip_flag” per CTB.

Each of the regions 183c and 183d also stores a control value “CtDepth”. “CtDepth” is information indicating the depth of the CU, and is used for coding of a syntax element “split_cu_flag”. Each of the regions 183c and 183d stores four control values “CtDepth” per CTB. Note that “split_cu_flag” is a flag indicating whether or not a CU at a specified position is divided in horizontal and vertical directions.

The context region 184 is divided into two context regions 184a and 184b. One of the context regions stores a context table of a certain picture, and the other stores a context table of the next picture. For example, it is assumed that a context table of the n-th picture Pn is stored in the context region 184a and a context table of the (n+1)-th picture P(n+1) is stored in the context region 184b. In this case, when entropy coding of the n-th picture Pn is completed, the context region 184a is updated using the context table of the (n+2)-th picture P(n+2).

Each of the context regions 184a and 184b stores context tables for the m CTB lines L0 to L(m-1) within a picture. The context table stores many pieces of context information (probability values) obtained by the entropy coding of up to the second CTB in the CTB line. A context table corresponding to a certain CTB line is referred to at the start of entropy coding of the next CTB line, and is used as initial context information. Furthermore, the context table also stores syntax elements such as “sao_merge_left_flag”, “sao_merge_up_flag”, “split_cu_flag”, “cbf_luna”, and “cu_transquant_bypass”.

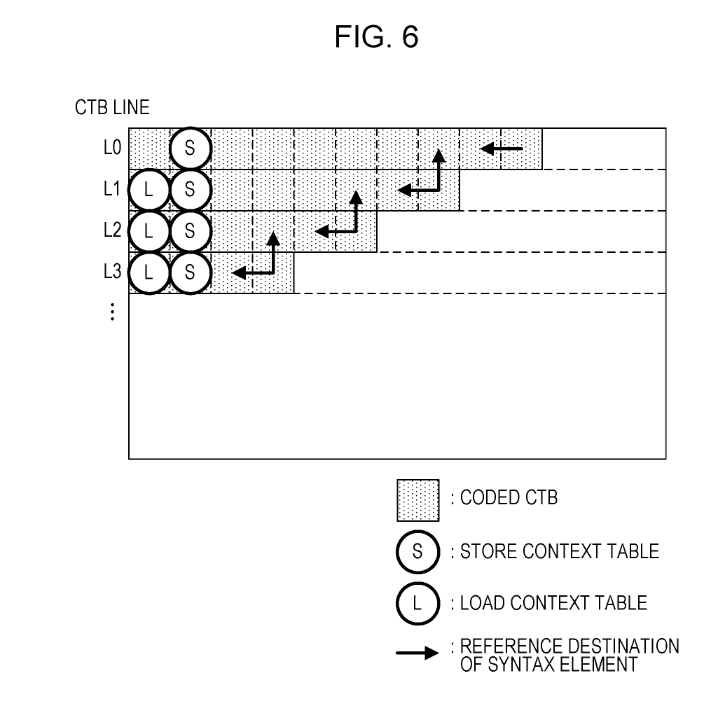

Next, WPP is described with reference to FIG. 6. FIG. 6 is a reference diagram for explaining coding processing by WPP. In the HEVC standard, WPP is introduced to enable efficient parallel execution of entropy coding by CABAC. In WPP, entropy coding of a certain CTB line is started after the completion of entropy coding of two CTBs in a CTB line thereabove. For example, in FIG. 6, entropy coding of the CTB line L1 is performed after the completion of entropy coding of the second CTB in the CTB line L0.

Such a mechanism enables context information obtained by entropy coding of the upper CTB line to be used as initial context information in entropy coding of the lower CTB line. For example, in FIG. 6, a certain coding core (first coding core) executes entropy coding of the second CTB in the CTB line L0, and then stores the obtained context table in a predetermined save area. Another coding core (second coding core) loads the context table stored in the save area and starts entropy coding of the CTB line L1 by using the context table. With such a mechanism, the context table is shared between the adjacent CTB lines. The coding efficiency is improved by using a probability value, which is used in entropy coding of a CTB at a position spatially close to a new CTB line, for entropy coding of the new CTB line.

However, with such a mechanism, the timing to start entropy coding of a certain CTB line is later than the timing to start entropy coding of a CTB line thereabove. The processing speed of the entropy coding may vary from one CTB line to another. However, even if the processing speed for the certain CTB line is higher than that for the CTB line thereabove, the processing of the CTB line may only be started at the timing later than the upper CTB line. Therefore, there is a problem that the processing efficiency during parallel coding may not be sufficiently improved. Moreover, there is also a problem that the processing becomes complicated since advanced synchronization control is desired, such as determining the timing to start processing for each CTB line according to the progress of the processing of the upper CTB line.

Furthermore, in order to entropy code a specific syntax element for a certain CTB, a syntax element of a CTB adjacent thereabove and a syntax element of a CTB adjacent to the left thereof are desired, as indicated by the arrows in FIG. 6. Therefore, execution timing of entropy coding of a certain CTB is after the completion of the generation of the syntax element of the CTB adjacent thereabove. When the syntax element generation and the entropy coding are executed in parallel as one processing unit for many CTB lines, an execution position of the processing in a certain CTB line may not go beyond a completion position of the processing in the CTB line thereabove. For this reason, even if the processing in the certain CTB line may be performed faster than the processing in the CTB line thereabove, the actual processing speed of the CTB line is limited by the processing speed of the CTB line thereabove. Therefore, there is a problem of deteriorated processing efficiency and reduced processing speed.

To counter such problems, the image processing circuit 100 according to this embodiment stores the context tables and the syntax elements for all the CTB lines in the RAM 180 before entropy coding. Then, the coding cores 110, 120, 130, and 140 execute entropy coding of the allocated CTB line by referring to the context tables and syntax elements stored in the RAM 180.

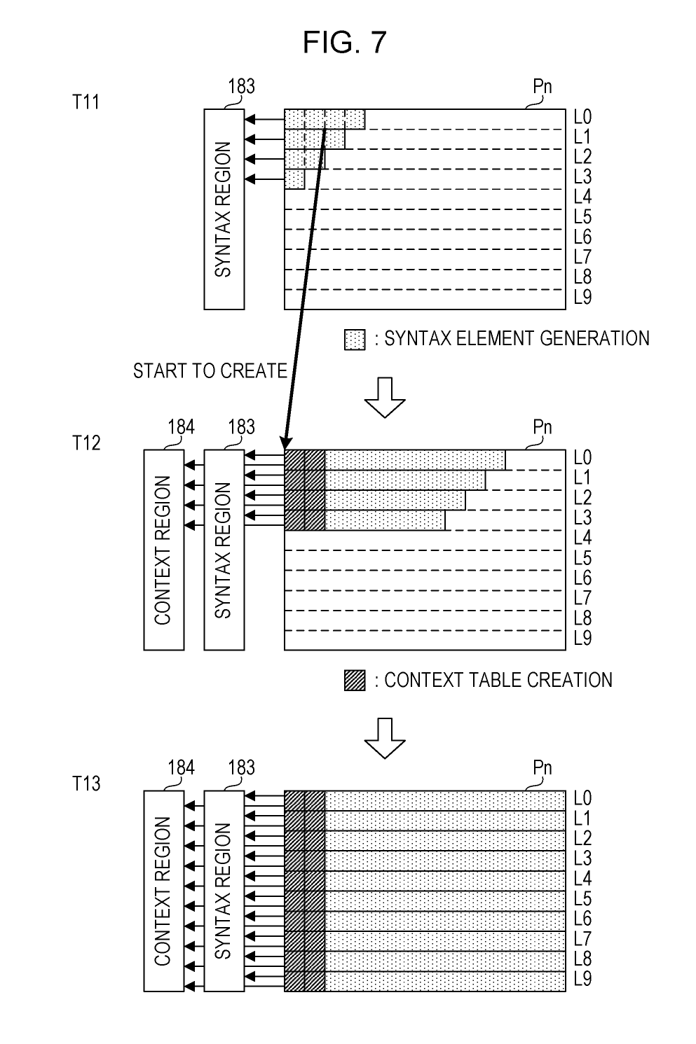

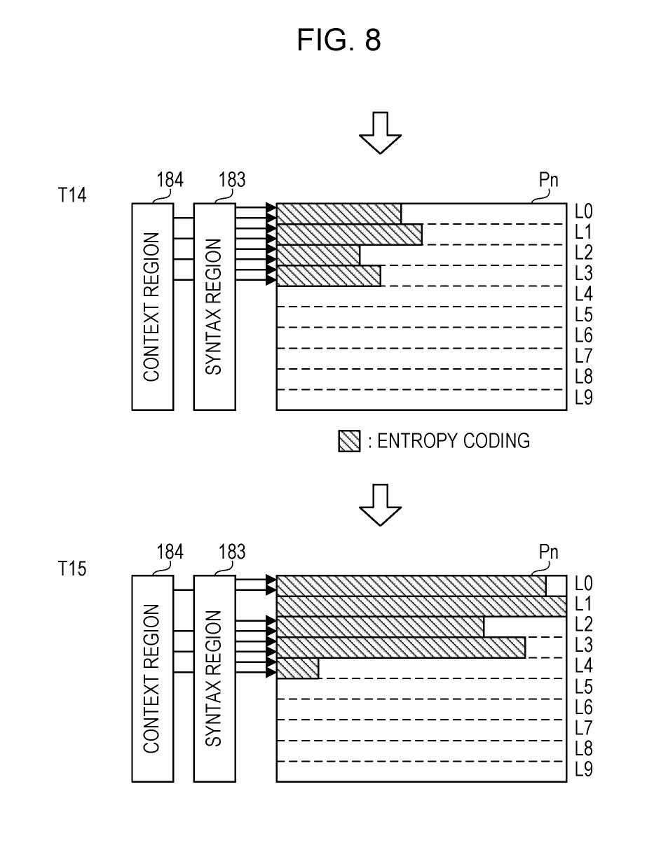

FIGS. 7 and 8 are diagrams illustrating an example of coding processing according to the second embodiment. In FIGS. 7 and 8, it is assumed that the n-th picture Pn is coded. Note that, for ease of explanation, it is assumed that the picture Pn includes ten CTB lines L0 to L9.

First, at a timing T11 illustrated in FIG. 7, the syntax element generators 111, 121, 131, and 141 start generating syntax elements of the CTB lines L0, L1, L2, and L3, respectively, for example. The syntax element generators 111, 121, 131, and 141 store the generated syntax elements in the syntax region 183.

Meanwhile, as indicated by a timing T12, the table creator 150 starts creating context tables for the CTB lines L0, L1, L2, and L3. Here, the table creator 150 may start creating a context table for a certain CTB line upon completion of the generation of the syntax elements of two CTBs in the CTB line thereabove. The table creator 150 stores the created context tables in the context region 184.

Upon completion of the syntax element generation for the CTB line L0, the syntax element generator 111 starts generating syntax elements for an unprocessed CTB line (for example, the CTB line L4). Likewise, the other syntax element generators 121, 131, and 141 may also start generating syntax elements for the unprocessed CTB line upon completion of the syntax element generation for a certain CTB line. Meanwhile, when syntax elements of up to two CTBs in a new CTB line are generated, the table creator 150 may create a context table for the CTB line.

In this manner, as indicated by a timing T13, the syntax elements of all the CTB lines are stored in the syntax region 183, and the context tables of all the CTB lines are stored in the context region 184. Note that the time desired for the processing of creating the context tables may be reduced by executing the context table creation processing in parallel with the syntax element generation processing.

Next, at a timing T14 illustrated in FIG. 8, the entropy coders 112, 122, 132, and 142 start entropy coding processing of the CTB lines L0, L1, L2, and L3, respectively, for example. Here, the context tables to be used to start the entropy coding of the CTB lines L1, L2, and L3 are read from the context region 184. Therefore, the entropy coders 112, 122, 132, and 142 may simultaneously start the entropy coding of the CTB lines L0, L1, L2, and L3. Thus, parallelism of the entropy coding is improved, and coding efficiency is enhanced.

Also, the upper adjacent syntax elements desired for entropy coding of CTBs on the CTB lines L1, L2, and L3 are read from the syntax region 183. Thus, synchronization does not have to be performed in the processing by the entropy coders 112, 122, 132, and 142. Therefore, for example, when the coding speed in the CTB line L1 below the CTB line L0 is faster than the coding speed in the CTB line L0, the entropy coding in the CTB line L1 may be completed first before the CTB line L0. Thus, the time desired for the entropy coding processing may be reduced as a whole. Moreover, control efficiency is also improved since synchronization control does not have to be performed.

Moreover, it is assumed that the entropy coding of the CTB line L1 among the CTB lines L0, L1, L2, and L3 is completed first. In this case, as indicated by a timing T15, the CTB line L4 is allocated, as the next processing target, to the entropy coder 122 that has completed the entropy coding of the CTB line L1. The entropy coder 122 executes entropy coding of the CTB line L4 by using the context table of the CTB line L3 stored in the context region 184 and the syntax element of the CTB line L3 stored in the syntax region 183.

Upon completion of entropy coding of a CTB line by a certain entropy coder as described above, an unprocessed CTB line may be allocated to the entropy coder to immediately execute entropy coding of the CTB line. In other words, a CTB line to be processed may be adaptively allocated to the entropy coder according to the processing speed of each CTB line. Thus, the parallelism of the entropy coding processing is improved, and the time desired for the entropy coding processing is reduced as a whole.

Note that, in the example of FIGS. 7 and 8 described above, the entropy coding is started after the syntax elements and the context tables are generated for all the CTB lines. However, after syntax elements and context tables are generated for four CTB lines, for example, entropy coding of the four CTB lines may be started.

For example, the syntax element generators 111, 121, 131, and 141 generate syntax elements of the CTB lines L0, L1, L2, and L3, respectively. At the same time, the table creator 150 creates context tables for the CTB lines L0, L1, L2, and L3, respectively. Upon completion of the above processing, the entropy coders 112, 122, 132, and 142 start entropy coding of the CTB lines L0, L1, L2, and L3 based on the generated syntax elements and context tables. Thus, the entropy coding of the CTB lines L0, L1, L2, and L3 may be asynchronously executed. Moreover, with the start of each entropy coding, the syntax element generators 111, 121, 131, and 141 generate syntax elements of the CTB lines L4, L5, L6, and L7, respectively, and the table creator 150 creates context tables for the CTB lines L4, L5, L6, and L7, respectively.

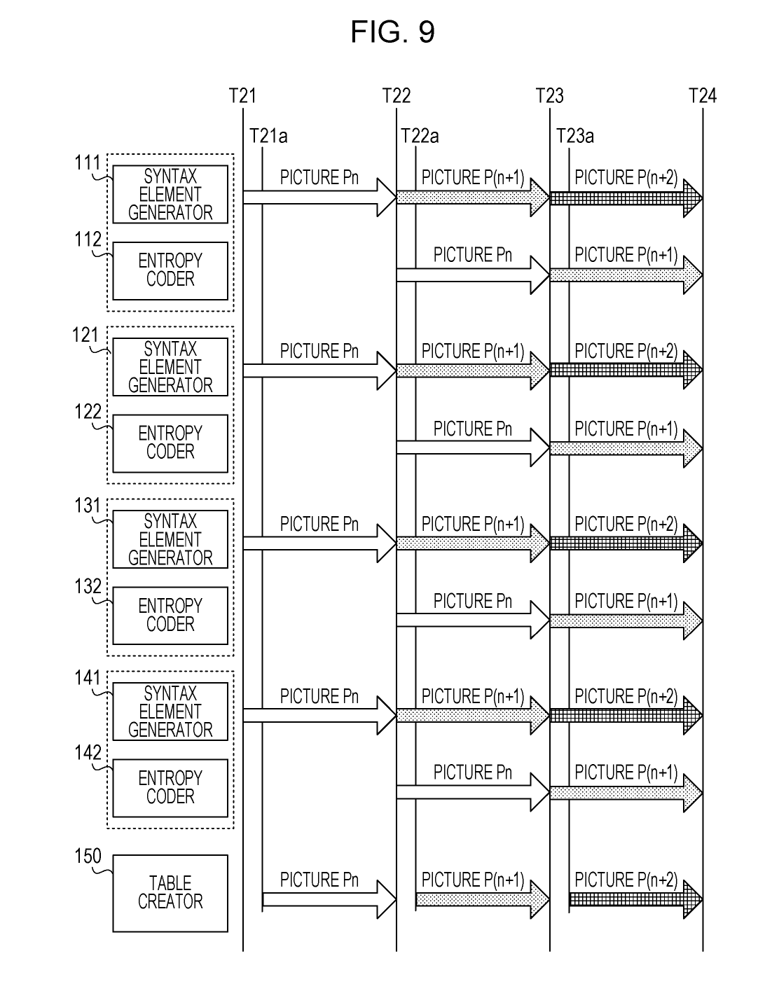

Meanwhile, when the entropy coding by the entropy coders 112, 122, 132, and 142 is started at the timing T14 in FIG. 8, the syntax element generators 111, 121, 131, and 141 may execute syntax element generation in parallel for the next picture P(n+1). Here, a processing timing for each picture is described with reference to FIG. 9.

FIG. 9 is a timing chart illustrating an example of processing execution timings. Note that the timings to start the respective processing illustrated in FIG. 9 are actually managed by the CPU 160.

At a timing T21, the syntax element generators 111, 121, 131, and 141 start generating syntax elements for the picture Pn. Also, at a timing T21a, the table creator 150 starts creating a context table for the picture Pn.

It is assumed that the syntax element generation and the context table creation for the picture Pn are completed at a timing T22. Then, the entropy coders 112, 122, 132, and 142 start entropy coding of the picture Pn by referring to the syntax elements and the context tables stored in the RAM 180 during a period between the timings T21 and T22. At the same time, the syntax element generators 111, 121, 131, and 141 start generating syntax elements for the next picture P(n+1). Also, at a timing T22a, the table creator 150 starts creating a context table for the picture P(n+1).

It is assumed that the entropy coding of the picture Pn as well as the syntax element generation and the context table creation for the picture P(n+1) are completed at a timing T23. Then, the entropy coders 112, 122, 132, and 142 start entropy coding of the picture P(n+1) by referring to the syntax elements and the context tables stored in the RAM 180 during a period between the timings T22 and T23. At the same time, the syntax element generators 111, 121, 131, and 141 start generating syntax elements for the next picture P(n+2). Also, at a timing T23a, the table creator 150 starts creating a context table for the picture P(n+2). Then, the entropy coding of the picture P(n+1) as well as the syntax element generation and the context table creation for the picture P(n+2) are completed at a timing T24.

In the example of FIG. 9, during the period between the timings T22 and T23, the entropy coding of the picture Pn is executed in parallel with the syntax element generation and the context table creation for the picture P(n+1). Likewise, during the period between the timings T23 and T24, the entropy coding of the picture P(n+1) is executed in parallel with the syntax element generation and the context table creation for the picture P(n+2).

In this embodiment, the processing by the coding cores 110, 120, 130, and 140 is divided into syntax element generation and entropy coding. Then, CTB lines of different pictures may be used as processing targets of the syntax element generation and entropy coding, respectively. Thus, as in the example of FIG. 9, during the execution of entropy coding of a certain picture, syntax element generation for the next picture may be executed, and the generated syntax element may be stored in the RAM 180. Moreover, during this period, the table creator 150 may create a context table for the next picture, and the created context table may be stored in the RAM 180.

Therefore, previously storing the syntax elements and context tables for all the CTB lines of a certain picture in the RAM 180 before entropy coding of the picture does not delay the coding processing. More specifically, the processing according to this embodiment may reduce the total processing time for the coding processing since synchronization does not have to be performed in the entropy coding between the CTB lines within a certain picture.

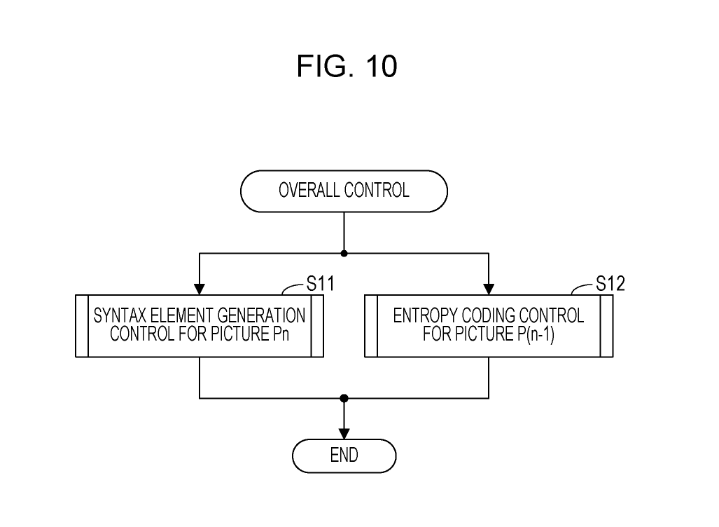

Next, with reference to a flowchart, the coding processing in the image processing circuit 100 is described. FIG. 10 is a flowchart illustrating an example of an overall control procedure for the coding processing.

### [Operation S11]

The CPU 160 executes syntax element generation control for the n-th picture Pn.

### [Operation S12]

The CPU 160 executes entropy coding control for the (n−1)-th picture P(n−1). The respective processings in Operations S11 and S12 are executed in parallel.

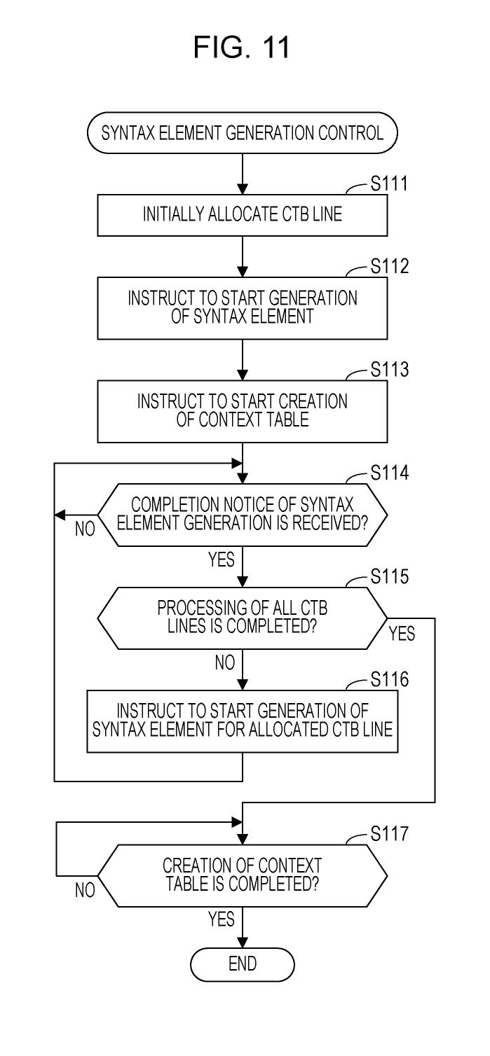

FIG. 11 is a flowchart illustrating a processing example of syntax element generation control. The processing illustrated in FIG. 11 corresponds to the processing of Operation S11 in FIG. 10.

### [Operation S111]

The CPU 160 initially allocates CTB lines to the syntax element generators 111, 121, 131, and 141, respectively. In this processing, the first to fourth CTB lines in the picture are allocated to the syntax element generators 111, 121, 131, and 141, respectively.

### [Operation S112]

The CPU 160 instructs the syntax element generators 111, 121, 131, and 141 to start generating syntax elements for the allocated CTB lines.

### [Operation S113]

The CPU 160 instructs the table creator 150 to start creating context tables for the respective CTB lines in the picture.

### [Operation S114]

The CPU 160 determines whether or not a completion notice of the syntax element generation is received from any one of the syntax element generators 111, 121, 131, and 141. When no completion notice is received, Operation S114 is executed again after a predetermined period of time. On the other hand, when the completion notice is received, processing of Operation S115 is executed.

### [Operation S115]

The CPU 160 determines whether or not the syntax element generation processing is completed for all the CTB lines of the picture. When the syntax element generation processing is not completed, processing of Operation S116 is executed. On the other hand, when the syntax element generation processing is completed, processing of Operation S117 is executed.

### [Operation S116]

The CPU 160 allocates the first CTB line, among unallocated CTB lines, to the syntax element generator that is the source of the completion notice received in Operation S114. The CPU 160 instructs the syntax element generator to start generating a syntax element for the allocated CTB line. Thereafter, the processing of Operation S114 is executed.

### [Operation S117]

The CPU 160 determines whether or not the context table creation processing is completed for all the CTB lines of the picture. When a completion notice of the context table creation processing is received from the table creator 150, the CPU 160 determines that the creation processing is completed. When the creation processing is not completed, the processing of Operation S117 is executed again after a predetermined period of time. On the other hand, when the creation processing is completed, the syntax element generation control for one picture is terminated.

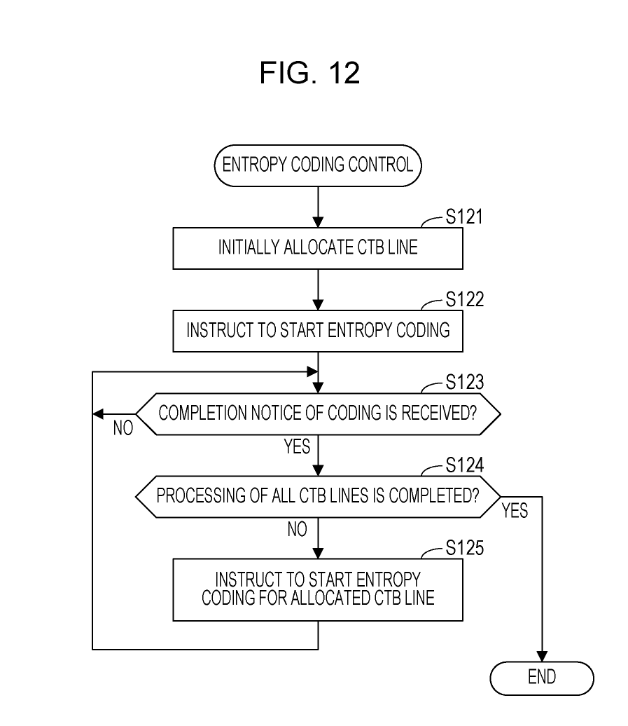

FIG. 12 is a flowchart illustrating a processing example of entropy coding control. The processing illustrated in FIG. 12 corresponds to the processing of Operation S12 in FIG. 10.

### [Operation S121]

The CPU 160 initially allocates CTB lines to the entropy coders 112, 122, 132, and 142, respectively. In this processing, the first to fourth CTB lines in the picture are allocated to the entropy coders 112, 122, 132, and 142, respectively.

### [Operation S122]

The CPU 160 instructs the entropy coders 112, 122, 132, and 142 to start entropy coding for the allocated CTB lines.

### [Operation S123]

The CPU 160 determines whether or not a completion notice of the entropy coding is received from any one of the entropy coders 112, 122, 132, and 142. When no completion notice is received, Operation S123 is executed again after a predetermined period of time. On the other hand, when the completion notice is received, processing of Operation S124 is executed.

### [Operation S124]

The CPU 160 determines whether or not the entropy coding processing is completed for all the CTB lines of the picture. When the entropy coding processing is not completed, processing of Operation S125 is executed. On the other hand, when the entropy coding processing is completed, the entropy coding control for one picture is terminated.

### [Operation S125]

The CPU 160 allocates the first CTB line, among unallocated CTB lines, to the entropy coder that is the source of the completion notice received in Operation S123. The CPU 160 instructs the entropy coder to start entropy coding for the allocated CTB line. Thereafter, the processing of Operation S123 is executed.

Note that, in Operation S121, the CPU 160 may allocate arbitrary CTB lines to the entropy coders 112, 122, 132, and 142, respectively. For example, the CPU 160 may allocate CTB lines, which are spaced apart from each other, to the entropy coders 112, 122, 132, and 142, respectively. Also, in Operation S125, again, the CPU 160 may allocate an arbitrary CTB line, among the unallocated CTB lines, to the entropy coder that is the source of the completion notice.

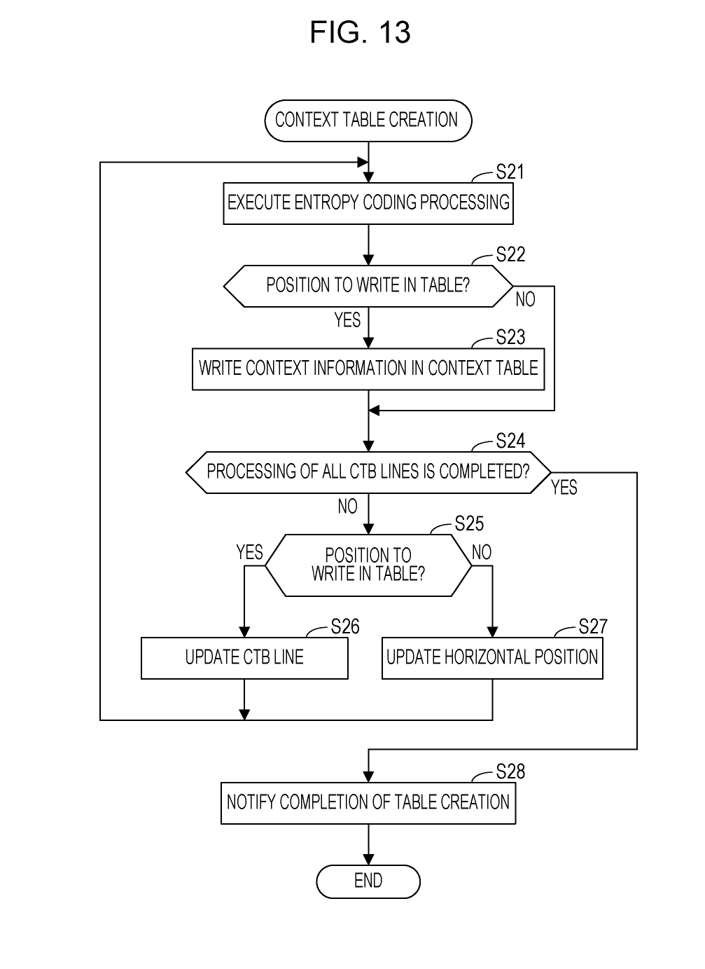

FIG. 13 is a flowchart illustrating a processing example of context table creation. The processing illustrated in FIG. 13 is started when the table creator 150 receives the instruction to start creating a context table, which is transmitted from the CPU 160 in Operation S113 of FIG. 11.

### [Operation S21]

The table creator 150 reads the syntax element for the CTB to be processed from the syntax region 183. The table creator 150 executes entropy coding processing based on the read syntax element. Note that the processing target in the first execution of Operation S21 is the upper left CTB within the picture.

### [Operation S22]

The table creator 150 determines whether or not the position of the CTB to be processed is the position to perform write in the context table. When the position of the CTB is determined to be the position to perform the write, processing of Operation S23 is executed. On the other hand, when the position of the CTB is determined not to be the position to perform the write, processing of Operation S24 is executed. Note that the position to perform the write is the second CTB in the CTB line.

### [Operation S23]

The table creator 150 writes the context information obtained in Operation S21 in the context table in the context region 184.

### [Operation S24]

The table creator 150 determines whether or not the context table creation is completed for all the CTB lines of the picture. When the context table creation is not completed, processing of Operation S25 is executed. On the other hand, when the context table creation is completed, processing of Operation S28 is executed.

### [Operation S25]

The table creator 150 determines whether or not the position of the CTB to be processed is the position to perform write in the context table. This determination may be made using the result of the determination in Operation S22. When the position of the CTB is determined to be the position to perform the write, processing of Operation S26 is executed. On the other hand, when the position of the CTB is determined not to be the position to perform the write, processing of Operation S27 is executed.

### [Operation S26]

The table creator 150 updates the processing target to the first CTB in the next CTB line. Then, the processing of Operation S21 is executed for the updated CTB to be processed.

### [Operation S27]

The table creator 150 updates the horizontal position of the CTB to be processed to the right by one CTB. Then, the processing of Operation S21 is executed for the updated CTB to be processed.

### [Operation S28]

The table creator 150 transmits a completion notice of the context table creation to the CPU 160.

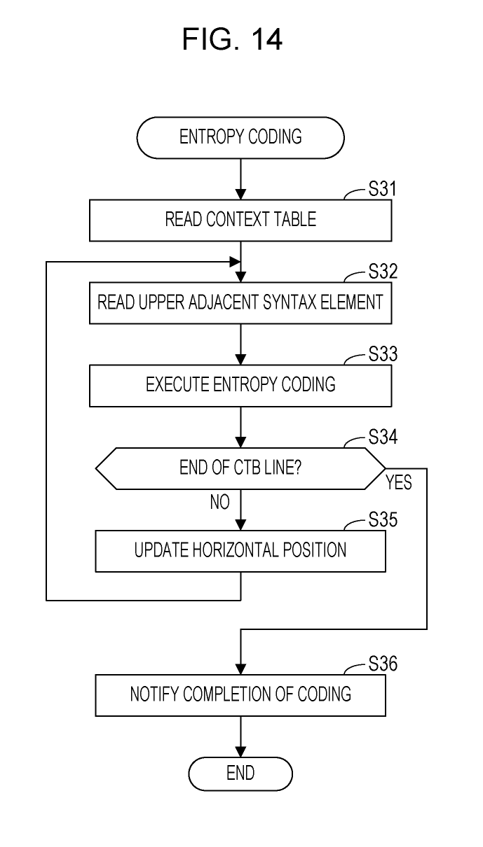

FIG. 14 is a flowchart illustrating a processing example of entropy coding. The processing contents of the entropy coding by the entropy coders 112, 122, 132, and 142 are the same. Therefore, here, only the processing by the entropy coder 112 is described. The processing illustrated in FIG. 14 is started when the entropy coder 112 receives the instruction to start entropy coding, which is transmitted from the CPU 160 in Operation S122 or Operation S125 of FIG. 12.

### [Operation S31]

The entropy coder 112 reads context information on a CTB line above the CTB line allocated by the CPU 160 from the context table in the context region 184. The entropy coder 112 sets the read context information as initial context information for the allocated CTB line. Note that, when the processing target is the first CTB line, a predetermined value is set as the initial context information.

### [Operation S32]

The entropy coder 112 reads a syntax element “cu_skip_flag” for a CTB adjacent above the CTB to be processed and a control value “CtDepth” for the same CTB from the syntax region 183. Note that the processing target in the first execution of Operation S32 is the first CTB in the CTB line allocated by the CPU 160. Also, when the processing target is the first CTB line, Operation S32 is skipped.

### [Operation S33]

The entropy coder 112 reads syntax elements for the CTB to be processed from the syntax region 183, and entropy codes the read syntax elements. When entropy coding “split_cu_flag” and “cu_skip_flag” among the syntax elements, the entropy coder 112 reads “cu_skip_flag” and “CtDepth” for the left adjacent CTB from the syntax region 183. Then, the entropy coder 112 entropy codes “split_cu_flag” and “cu_skip_flag” by using “cu_skip_flag” and “CtDepth” for the left adjacent CTB and “cu_skip_flag” and “CtDepth” for the upper adjacent CTB read in Operation S32.

### [Operation S34]

The entropy coder 112 determines whether or not the CTB to be processed is the end of the CTB line. When the CTB to be processed is not the end, processing of Operation S35 is executed. On the other hand, when the CTB to be processed is the end, processing of Operation S36 is executed.

### [Operation S35]

The entropy coder 112 updates the horizontal position of the CTB to be processed to the right by one CTB. Then, the processing of Operation S32 is executed for the updated CTB to be processed.

### [Operation S36]

The entropy coder 112 transmits a completion notice of the entropy coding to the CPU 160.

According to the processing of FIG. 14 described above, the entropy coder 112 reads the context table for the upper adjacent CTB line from the context region 184 storing the context tables already calculated for all the CTB lines. Then, the entropy coder 112 starts entropy coding processing by using the read context table. Thus, upon receipt of the instruction to start the entropy coding from the CPU 160, the entropy coder 112 may immediately start the entropy coding of the CTB line to be processed, regardless of the progress of the entropy coding for the CTB line adjacent thereabove.

Therefore, when the entropy coders 112, 122, 132, and 142 are instructed to start entropy coding in Operation S122 of FIG. 12, the entropy coders 112, 122, 132, and 142 may simultaneously start the entropy coding. Thus, the parallelism of the entropy coding processing may be improved, and the total processing time may be reduced. Moreover, the control is simplified since synchronization does not have to be performed in the processing among the entropy coders 112, 122, 132, and 142. Furthermore, also when a new CTB line is allocated to a certain entropy coder in Operation S125 of FIG. 12, the entropy coder may immediately start entropy coding of the new CTB line. Thus, the processing time may be reduced.

Moreover, according to the processing of FIG. 14, the entropy coder 112 executes the processing by reading the syntax element of the upper adjacent CTB from the syntax region 183 storing the syntax elements already calculated for all the CTB lines. Thus, no waiting time occurs for syntax element creation in the upper CTB line during execution of entropy coding of the CTB line. Therefore, the entropy coder 112 may execute the entropy coding without stopping the processing in the middle from the top to the end of the allocated CTB line.

Thus, after the entropy coding is started by the entropy coders 112, 122, 132, and 142 in Operation S122 of FIG. 12, the entropy coding is executed without synchronization thereamong. Here, in the method illustrated in FIG. 6, even if the entropy coding is executed in parallel by the entropy coders 112, 122, 132, and 142, the entropy coding for the CTB line closest to the top thereamong is completed first. This embodiment, on the other hand, does not have such limitation, and any of the entropy coders 112, 122, 132, and 142 may first complete the entropy coding to the end of the CTB line. Moreover, in the first Operation S123 after Operation S122 of FIG. 12, the completion notice may be received from any of the entropy coders 112, 122, 132, and 142. Therefore, the parallelism of the entropy coding is improved, and the time desired for the entropy coding may be reduced.

Furthermore, the next unprocessed CTB line is allocated to the entropy coder that has received the completion notice, and entropy coding of the CTB line is immediately started. Therefore, a CTB line may be adaptively allocated to the entropy coder. Thus, processing efficiency is improved, and the processing time may be reduced.

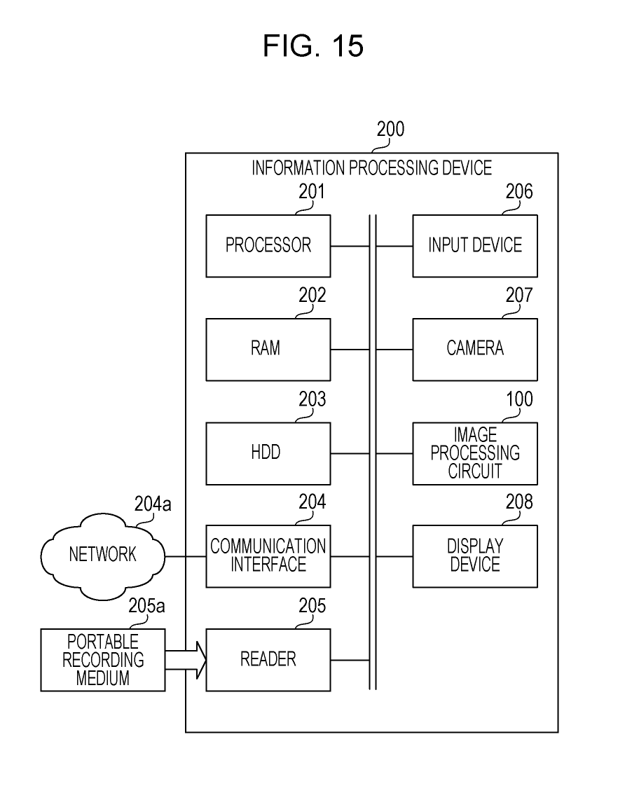

Next, description is given of an example of a device including the image processing circuit 100 described above. FIG. 15 is a diagram illustrating a hardware configuration example of an information processing device including an image processing circuit. An information processing device 200 is realized as a portable information processing terminal such as a smartphone, a tablet terminal, and a notebook personal computer (PC).

The information processing device 200 is entirely controlled by a processor 201. The processor 201 may be a multiprocessor. The processor 201 is a CPU, an MPU, a DSP, an ASIC or a PLD, for example. Alternatively, the processor 201 may be a combination of two or more of the CPU, MPU, DSP, ASIC, and PLD.

A RAM 202 and many peripheral devices including the image processing circuit 100 described above are connected to the processor 201 through a bus. The RAM 202 is used as a main storage of the information processing device 200. The RAM 202 temporarily stores at least some of an operating system (OS) program and application programs to be executed by the processor 201. The RAM 202 also stores various data desired for processing by the processor 201.

The peripheral devices connected to the processor 201 include, besides the image processing circuit 100, an HDD 203, a communication interface 204, a reader 205, an input device 206, a camera 207, and a display device 208.

The HDD 203 is used as an auxiliary storage of the information processing device 200. The HDD 203 stores the OS program, the application programs, and various data. Note that, as the auxiliary storage, any other type of non-volatile storage may be used, such as a solid state drive (SSD).

The communication interface 204 transmits and receives data to and from the other devices through a network 204a. The input device 206 transmits a signal corresponding to an input operation to the processor 201. Examples of the input device 206 include a keyboard, a pointing device, and the like. Examples of the pointing device include a mouse, a touch panel, a touch pad, a track ball, and the like.

A portable recording medium 205a is attached to and detached from the reader 205. The reader 205 reads data recorded in the portable recording medium 205a and transmits the data to the processor 201. Examples of the portable recording medium 205a include an optical disk, a magneto-optical disk, a semiconductor memory, and the like.

The camera 207 takes an image with an imaging element. The image processing circuit 100 performs compression coding processing on the image taken by the camera 207, for example. Note that the image processing circuit 100 may perform compression coding processing on an image inputted to the information processing device 200 through the network 204a or the portable recording medium 205a, for example. The display device 208 displays images according to instructions from the processor 201. Examples of the display device include a liquid crystal display, an organic electroluminescence (EL) display, and the like.

Note that at least some of the processing by the CPU 160 in the image processing circuit 100 may be executed by the processor 201. Moreover, at least some of not only the processing by the CPU 160 but also the processing by the image processing circuit 100 may be executed by the processor 201. Furthermore, the entire processing by the image processing circuit 100 may be executed by the processor 201, instead of mounting the image processing circuit 100 in the information processing device 200. In either case, the processor 201 realizes the above processing by executing a predetermined program.

### Third Embodiment

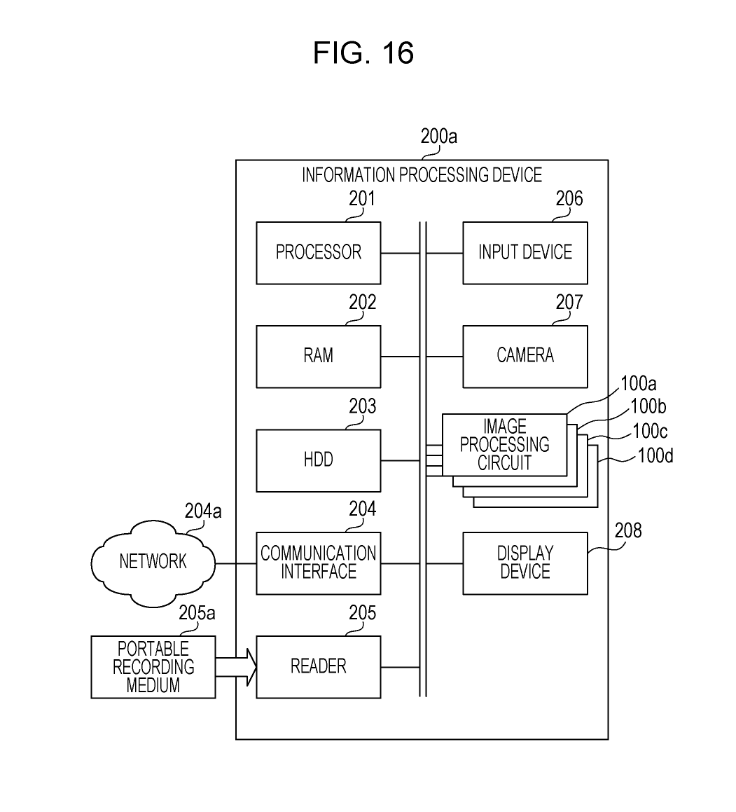

FIG. 16 is a diagram illustrating a configuration example of an information processing device according to a third embodiment. Hereinafter, only differences between the second and third embodiments are described, and description of points shared by the both is omitted.

An information processing device 200a according to the third embodiment is obtained by modifying the information processing device 200 illustrated in FIG. 15 as below. The information processing device 200a is different from the information processing device 200 illustrated in FIG. 15 in including image processing circuits 100a, 100b, 100c, and 100d, instead of one image processing circuit 100. The image processing circuits 100a, 100b, 100c, and 100d have the same internal configuration as that of the image processing circuit 100 according to the second embodiment. Note that the number of the image processing circuits is not limited to four, but may be any number of two or more.

A processor 201 in the information processing device 200a controls coding processing in the image processing circuits 100a, 100b, 100c, and 100d in an integrated manner. The processor 201 first allocates individual tiles to the image processing circuits 100a, 100b, 100c, and 100d, respectively. The tiles are rectangle-shaped regions dividing a picture. Hereinafter, in this embodiment, it is assumed that a picture is divided into four tiles of the same size. The image processing circuits 100a, 100b, 100c, and 100d execute the same coding processing as that executed by the image processing circuit 100 according to the second embodiment, by using the allocated tiles as a processing target.

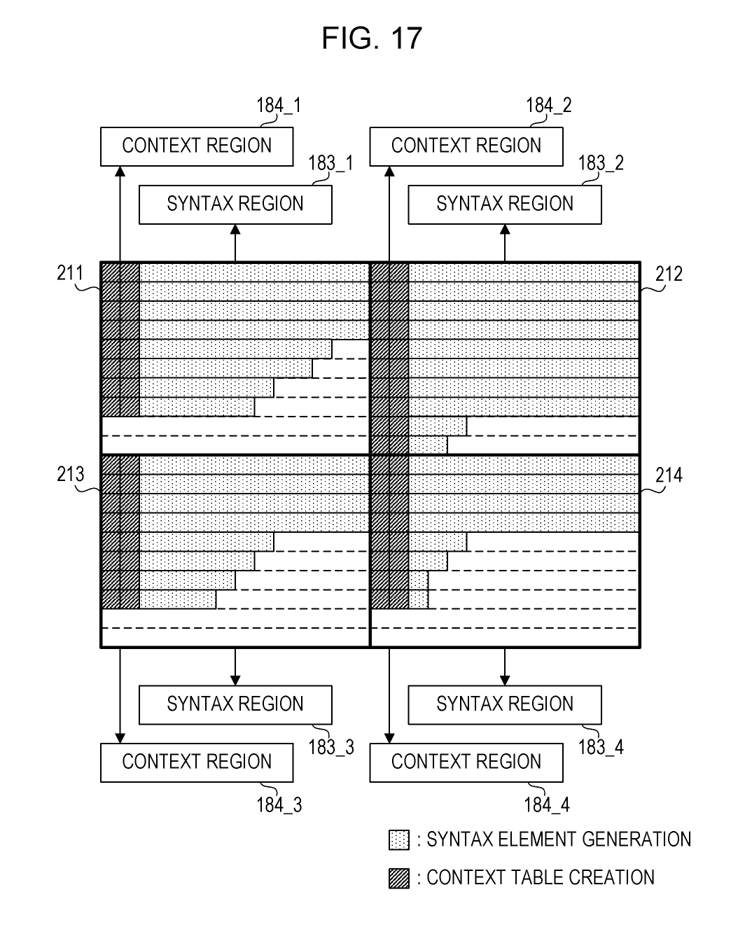

Here, with reference to FIGS. 17 to 19, description is given of an example of the coding processing according to the third embodiment. FIG. 17 is a diagram illustrating a processing example of syntax element generation in each tile.

The processor 201 allocates tiles 211, 212, 213, and 214 to the image processing circuits 100a, 100b, 100c, and 100d, respectively, for example. In the image processing circuit 100a, a syntax element generator included therein performs processing to generate syntax elements for all CTB lines in the tile 211. The generated syntax elements are stored in a syntax region 183_1 in a RAM in the image processing circuit 100a. Also, in the image processing circuit 100a, a table creator 150 included therein creates context tables for all the CTB lines in the tile 211. The created context tables are stored in a context region 184_1 in the RAM in the image processing circuit 100a.

The image processing circuits 100b, 100c, and 100d also execute the same processing as that executed by the image processing circuit 100a, with the tiles 212, 213, and 214 as the processing targets, respectively. In the image processing circuit 100b, syntax elements and context tables for all CTB lines are stored in a syntax region 183_2 and a context region 184_2, respectively, in a RAM in the image processing circuit 100b. In the image processing circuit 100c, syntax elements and context tables for all CTB lines are stored in a syntax region 183_3 and a context region 184_3, respectively, in a RAM in the image processing circuit 100c. In the image processing circuit 100d, syntax elements and context tables for all CTB lines are stored in a syntax region 183_4 and a context region 184_4, respectively, in a RAM in the image processing circuit 100d.

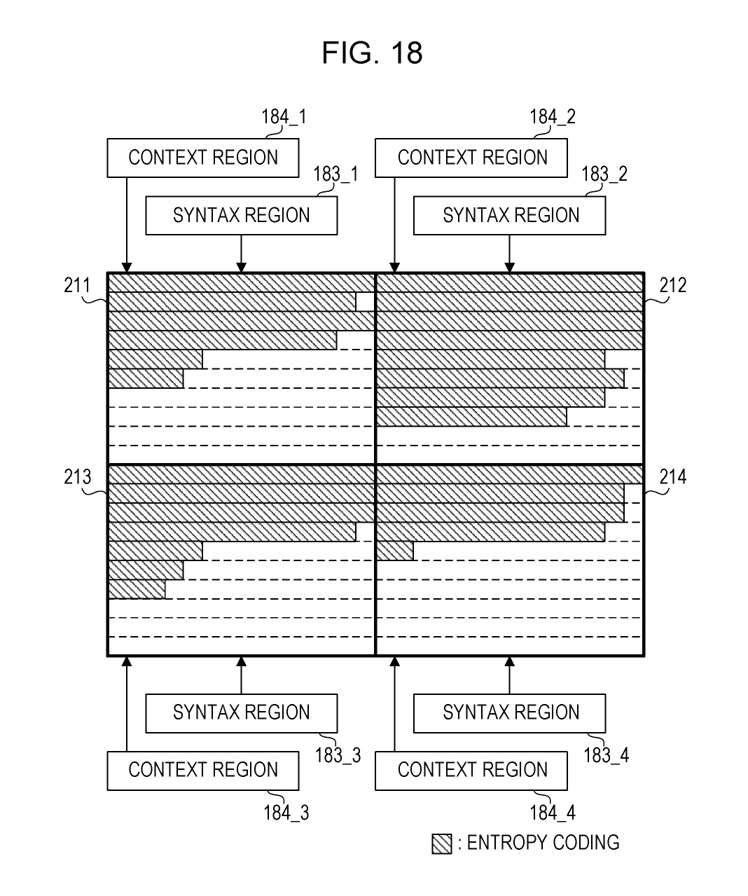

FIG. 18 is a diagram illustrating a processing example of entropy coding in each tile. Upon completion of the syntax generation and the context table creation for the respective tiles 211, 212, 213, and 214 by the processing of FIG. 17, entropy coding of the tiles 211, 212, 213, and 214 is started as illustrated in FIG. 17.

More specifically, in the image processing circuit 100a, an entropy coder included therein performs processing to execute entropy coding of syntax elements for all the CTB lines in the tile 211. In this event, at the start of entropy coding of the CTB lines except for the first CTB line, the entropy coder in the image processing circuit 100a reads a context table for a CTB line adjacent thereabove from the context region 184_1. The entropy coder in the image processing circuit 100a sets the read context table as initial context information, and starts entropy coding of the CTB line to be processed. Moreover, for entropy coding of “split_cu_flag” and “cu_skip_flag”, the entropy coder in the image processing circuit 100a reads “cu_skip_flag” and “CtDepth” for the respective CTBs in the upper CTB line from the syntax region 183_1.

The image processing circuits 100b, 100c, and 100d also execute the same processing as that executed by the image processing circuit 100a, with the tiles 212, 213, and 214 as the processing targets, respectively. More specifically, when the CTB lines other than the first CTB line in the tile 212 are entropy coded by the entropy coder in the image processing circuit 100b, a context table for the upper CTB line is read from the context region 184_2. Also, “cu_skip_flag” and “CtDepth” for the respective CTBs in the upper CTB line are read from the syntax region 183_2.

When the CTB lines other than the first CTB line in the tile 213 are entropy coded by the entropy coder in the image processing circuit 100c, a context table for the upper CTB line is read from the context region 184_3. Also, “cu_skip_flag” and “CtDepth” for the respective CTBs in the upper CTB line are read from the syntax region 183_3.

When the CTB lines other than the first CTB line in the tile 214 are entropy coded by the entropy coder in the image processing circuit 100d, a context table for the upper CTB line is read from the context region 184_4. Also, “cu_skip_flag” and “CtDepth” for the respective CTBs in the upper CTB line are read from the syntax region 183_4.

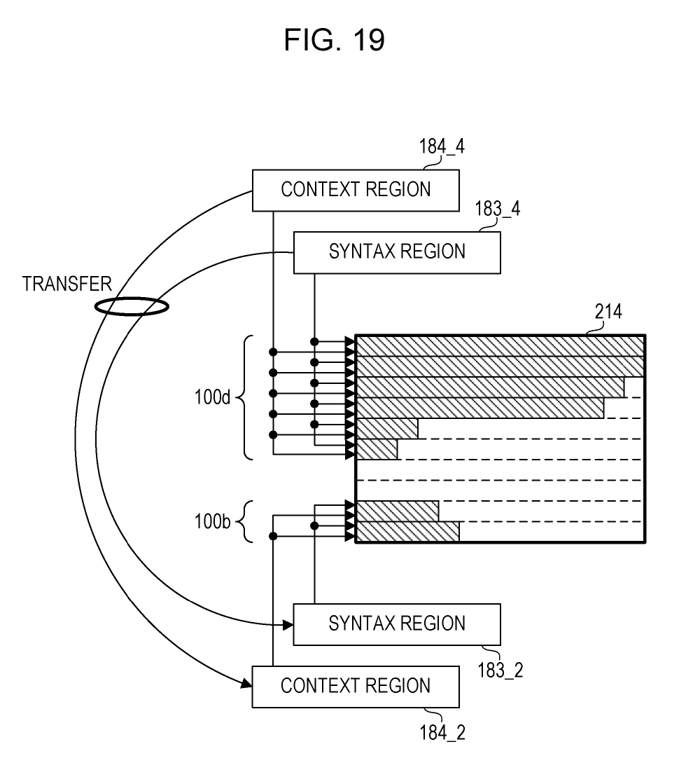

FIG. 19 is a diagram illustrating a processing example when the entropy coding in a certain tile is completed. The time desired for the entropy coding by the image processing circuits 100a, 100b, 100c, and 100d varies depending on image complexity in each of the tiles 211, 212, 213, and 214, and the like. Here, it is assumed that, as an example, the entropy coding of the tile 212 by the image processing circuit 100b is completed first. In this event, the processor 201 allows the image processing circuit 100b to assist entropy coding in any of the tiles in which the entropy coding is not completed. Here, it is assumed that, as an example, the processor 201 allows the image processing circuit 100b to assist entropy coding in the tile 214.

The processor 201 allows the entropy coder in the image processing circuit 100b to execute entropy coding of two CTB lines from the end among the CTB lines for which entropy coding is not executed yet in the tile 214, for example. Here, the syntax elements for all the CTB lines in the tile 214 are already stored in the syntax region 183_4 in the image processing circuit 100d, and the context tables for all the CTB lines in the tile 214 are already stored in the context region 184_4. Therefore, the processor 201 transfers information desired for entropy coding of the two CTB lines from the end of the tile 214 to the syntax region 183_2 and the context region 184_2 in the image processing circuit 100b from the syntax region 183_4 and the context region 184_4 in the image processing circuit 100d. Then, the processor 201 allows the entropy coder in the image processing circuit 100b to execute entropy coding of two CTB lines from the end of the tile 214.

The entropy coder in the image processing circuit 100b may immediately start the entropy coding of the two CTB lines from the end of the tile 214 by using the context table transferred to the context region 184_2. Moreover, the entropy coder in the image processing circuit 100b may execute the entropy coding of the two CTB lines from the end of the tile 214 in parallel without synchronization between the CTB lines by using the information transferred to the syntax region 183_2. Furthermore, synchronization does not have to be performed in the entropy coding between the entropy coder in the image processing circuit 100b and the entropy coder in the image processing circuit 100d. Therefore, the entropy coding of the tile 214 may be executed in parallel by both of the image processing circuits 100b and 100d. Thus, the time desired for the entropy coding may be reduced by simple control.

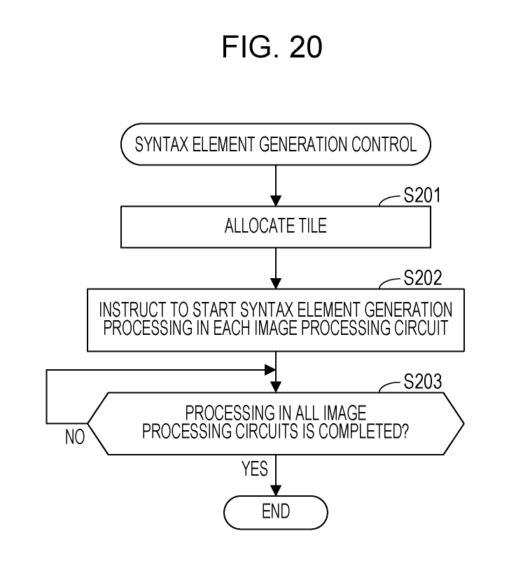

FIG. 20 is a flowchart illustrating an example of a control procedure for syntax element generation by the processor.

### [Operation S201]

The processor 201 allocates tiles to be processed to the image processing circuits 100a, 100b, 100c, and 100d, respectively.

### [Operation S202]

The processor 201 instructs the image processing circuits 100a, 100b, 100c, and 100d to start syntax element generation processing of the allocated tiles. This instruction is notified to each of the CPUs in the image processing circuits 100a, 100b, 100c, and 100d. Thus, the CPU in each of the image processing circuits 100a, 100b, 100c, and 100d follows the same procedure as that illustrated in FIG. 11 to perform control to execute syntax element generation and context table creation for the allocated tile.

### [Operation S203]

Upon completion of the syntax element generation and the context table creation for the allocated tile, the CPU in each of the image processing circuits 100a, 100b, 100c, and 100d transmits a completion notice to the processor 201. Then, the processor 201 determines whether or not the completion notices are received from all the image processing circuits 100a, 100b, 100c, and 100d. When there is an image processing circuit that has received no completion notice, the processing of Operation S203 is executed after a predetermined period of time. Then, when the completion notices are received from all the image processing circuits 100a, 100b, 100c, and 100d, the processing of FIG. 20 is terminated.

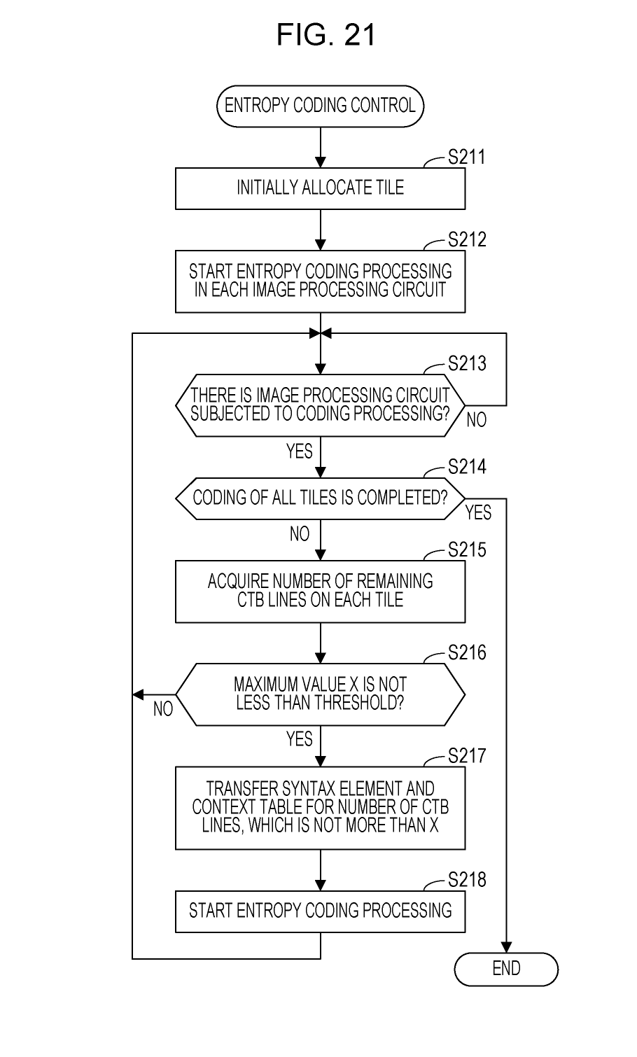

FIG. 21 is a flowchart illustrating an example of a control procedure for entropy coding by the processor. Note that, in parallel with the processing of FIG. 21, the processor 201 allows the syntax generators and the table creators in the respective image processing circuits 100a, 100b, 100c, and 100d to execute syntax element generation and context table creation for each tile in the next picture.

### [Operation S211]

The processor 201 initially allocates tiles to the image processing circuits 100a, 100b, 100c, and 100d, respectively.

### [Operation S212]

The processor 201 instructs the image processing circuits 100a, 100b, 100c, and 100d to start entropy coding processing for the allocated tiles. This instruction is notified to each of the CPUs in the image processing circuits 100a, 100b, 100c, and 100d. Thus, the CPU in each of the image processing circuits 100a, 100b, 100c, and 100d follows the same procedure as that illustrated in FIG. 12 to perform control to execute entropy coding for the allocated tile.

### [Operation S213]

Upon completion of the entropy coding for the allocated tile, the CPU in each of the image processing circuits 100a, 100b, 100c, and 100d transmits a completion notice to the processor 201. Then, the processor 201 determines whether or not the completion notice is received from any of the image processing circuits 100a, 100b, 100c, and 100d. When no completion notice is received, Operation S213 is executed again after a predetermined period of time. On the other hand, when the completion notice is received, processing of Operation S214 is executed.

### [Operation S214]

The processor 201 determines whether or not the entropy coding is completed for all the tiles. When the entropy coding is not completed, processing of Operation S215 is executed. On the other hand, when the entropy coding is completed, the processing of FIG. 21 is terminated.

### [Operation S215]

The processor 201 acquires the number of remaining CTB lines in each tile from the CPU in each of the image processing circuits 100a, 100b, 100c, and 100d. The number of remaining CTB lines is the number of CTB lines for which the entropy coding is not started.

### [Operation S216]

The processor 201 determines whether or not the maximum value X of the number of remaining CTB lines acquired in Operation S215 is not less than a predetermined threshold. The threshold is set to a predetermined value of 1 or more. When the maximum value X is not less than the threshold, processing of Operation S217 is executed. On the other hand, when the maximum value X is less than the threshold, the processing of Operation S213 is executed.

### [Operation S217]

The processor 201 specifies the image processing circuit that is entropy coding the tile in which the number of remaining CTB lines is the maximum value X. The processor 201 also specifies X CTB lines or less from the end of the tile as CTB lines to be newly allocated. For example, the processor 201 specifies X/2 CTB lines from the end of the tile.

The processor 201 reads information desired for entropy coding of the specified CTB lines from the syntax region and the context region in the specified image processing circuit. The processor 201 transfers the read information to the syntax region and the context region in the image processing circuit that is the source of the completion notice in Operation S213.

### [Operation S218]

The processor 201 instructs the CPU in the image processing circuit that is the transfer destination to start entropy coding processing of the specified CTB lines. Thus, each of the entropy coders in the image processing circuit that is the transfer destination executes the entropy coding of the specified CTB lines. Thereafter, the processing of Operation S213 is executed.

Note that the processing functions of the devices (for example, the image coding device 10, the image processing circuits 100, 100a, 100b, 100c, and 100d, and the information processing devices 200 and 200a) described in the above embodiments may be realized by a computer. In such a case, a program describing processing contents of functions that the respective devices preferably have is provided, and the above processing functions are realized on the computer by executing the program on the computer. The program describing the processing contents may be recorded in a computer-readable recording medium. Examples of the computer-readable recording medium include a magnetic storage device, an optical disk, a magneto-optical recording medium, a semiconductor memory, and the like. Examples of the magnetic storage device include a hard disk device (HDD), a flexible disk (FD), a magnetic tape, and the like. Examples of the optical disk include a digital versatile disc (DVD), a DVD-RAM, a compact disc (CD)-ROM, a CD-R (Recordable)/RW (ReWritable), and the like. Examples of the magneto-optical recording medium include a magneto-optical disk (MO) and the like.

For distribution of the program, a portable recording medium such as a DVD and a CD-ROM having the program recorded thereon, for example, is sold. Alternatively, the program may be stored in a storage device of a server computer, and the program may be transferred to another computer from the server computer.

A computer to execute a program stores the program recorded on the portable recording medium or the program transferred from the server computer in a storage device of its own. Then, the computer reads the program from its own storage device and executes processing according to the program. Note that the computer may also read the program directly from the portable recording medium and execute processing according to the program. Alternatively, the computer may also execute processing, upon every transfer of a program from the server computer connected through a network, according to the program received.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image coding device comprising:
a storage unit; and
an operation unit configured to execute a procedure, the procedure comprising:
calculating a plurality of syntax elements corresponding to a plurality of divided regions obtained by dividing an image along horizontal dividing lines;
storing the plurality of syntax elements in the storage unit; and
executing first entropy coding processing for a first divided region among the plurality of divided regions, in parallel with second entropy coding processing for a second divided region adjacent below the first divided region among the plurality of divided regions,
wherein the second entropy coding processing includes processing of reading a syntax element corresponding to the first divided region among the plurality of syntax elements from the storage unit.

2. An image coding device comprising:
a storage unit; and
an operation unit configured to execute a procedure, the procedure comprising:
calculating a plurality of syntax elements and a plurality of pieces of context information corresponding to a plurality of divided regions obtained by dividing an image along horizontal dividing lines;
storing the plurality of syntax elements and the plurality of pieces of context information in the storage unit; and
executing first entropy coding processing for a first divided region among the plurality of divided regions in parallel with second entropy coding processing for a third divided region among the plurality of divided regions,
wherein the first entropy coding processing includes processing of reading a first syntax element corresponding to the first divided region among the plurality of syntax elements, a second syntax element corresponding to a second divided region adjacent above the first divided region among the plurality of syntax elements, and a first context information corresponding to the first divided region among the plurality of pieces of context information from the storage unit, and
wherein the second entropy coding processing includes processing of reading a third syntax element corresponding to the third divided region among the plurality of syntax elements, a fourth syntax element corresponding to a fourth divided region adjacent above the third divided region among the plurality of syntax elements, and a second context information corresponding to the third divided region among the plurality of pieces of context information from the storage unit.

3. The image coding device according to claim 2,
wherein the operation unit executes, in parallel, calculation of the plurality of syntax elements and the plurality of pieces of context information, storage of the plurality of syntax elements and the plurality of pieces of context information in the storage unit, and third entropy coding processing for another image preceding the image, before execution of the first entropy coding processing and the second entropy coding processing.

4. The image coding device according to claim 2,
wherein, when the second entropy coding processing is completed before the first entropy coding processing is completed, the operation unit starts fourth entropy coding processing for a fifth divided region among the plurality of divided regions,
wherein, the fourth entropy coding processing includes processing of reading a fifth syntax element corresponding to the fifth divided region among the plurality of syntax elements, a sixth syntax element corresponding to a sixth divided region adjacent above the fifth divided region among the plurality of syntax elements, and a third context information corresponding to the fifth divided region among the plurality of pieces of context information from the storage unit.

5. The image coding device according to claim 3,
wherein, when the second entropy coding processing is completed before the first entropy coding processing is completed, the operation unit starts fourth entropy coding processing for a fifth divided region among the plurality of divided regions,
wherein, the fourth entropy coding processing includes processing of reading a fifth syntax element corresponding to the fifth divided region among the plurality of syntax elements, a sixth syntax element corresponding to a sixth divided region adjacent above the fifth divided region among the plurality of syntax elements, and a third context information corresponding to the fifth divided region among the plurality of pieces of context information from the storage unit.

6. An image coding device comprising:
a storage unit; and
an operation unit configured to execute a procedure, the procedure comprising:
calculating a plurality of syntax elements corresponding to a plurality of divided regions obtained by dividing an image along horizontal dividing lines;
storing the plurality of syntax elements in the storage unit;
executing first entropy coding processing for a first divided region among the plurality of divided regions, in parallel with second entropy coding processing for a second divided region adjacent below the first divided region among the plurality of divided regions,
wherein the second entropy coding processing includes processing of reading a syntax element corresponding to the first divided region among the plurality of syntax elements from the storage unit;
executing third entropy coding processing for a second region included in the image in parallel with the first entropy coding processing and the second entropy coding processing; and
executing fourth entropy coding processing for a third divided region among the plurality of divided regions upon completion of the third entropy coding processing,
wherein the fourth entropy coding processing includes processing of reading a second syntax element corresponding to a fourth divided region adjacent above the third divided region among the plurality of syntax elements from the storage unit.

7. The image coding device according to claim 6,
wherein the procedure of the operation unit further comprising:
calculating a plurality of pieces of context information corresponding to the plurality of divided regions, respectively, based on the plurality of syntax elements; and
storing the plurality of pieces of context information in the storage unit,
wherein, after storing the plurality of syntax elements and the plurality of pieces of context information in the storage unit, the operation unit starts the first entropy coding processing and starts the second entropy coding processing based on first context information corresponding to the first divided region among the plurality of pieces of context information stored in the storage unit, and
wherein, upon completion of the third entropy coding processing, the operation unit starts the fourth entropy coding processing based on second context information corresponding to the fourth divided region among the plurality of pieces of context information stored in the storage unit.
